(19) United States
(12) Patent Application Publication
(10) Pub. No.: US 2026/0172260 A1
(43) Pub. Date: Jun. 18, 2026

(54) SECRETS MANAGEMENT SYSTEM

(71) Applicant: Stripe, Inc., South San Francisco, CA (US)

(72) Inventors: Soumil Mukherjee, San Francisco, CA (US); Hans Nielsen, Sunnyvale, CA (US); Daniel Dreier, Rochester, NY (US); Ankit Khandelwal, Brooklyn, NY (US); Jordan Wright, Aledo, TX (US); Kelby Ludwig, Austin, TX (US); Cameron Gagnon, Acton, MA (US); Paul Carleton, London (GB); Adam Stubblefield, Belfair, WA (US)

(21) Appl. No.: 18/983,027

(22) Filed: Dec. 16, 2024

(51) Int. Cl. H04L 9/32; H04L 9/08

(52) U.S. Cl. CPC H04L 9/3247; H04L 9/0825

(57) ABSTRACT

A method and server system for using secured secrets by distributed systems are disclosed. The method can include receiving, from a first user system, a request for a credential. The method can further include in response to the request, generating a credential blob and signature data of the credential blob. The credential blob can include encrypted secrets data and credential metadata. The method can further include sending, to the first user system, the credential blob and the signature data. The method can further include receiving, from the first user system, a service request with the credential blob and the signature data. The method can further include in response to the service request, building artifact data that includes the credential blob. The method can further include deploying the artifact data and the signature data to a second user system.

### BACKGROUND

Secrets management systems are tools generally used by organizations to manage and protect sensitive data and secrets. They store, secure, and control access to sensitive data, such as passwords, application programming interface (API) keys, encryption keys, etc. For example, a secrets management system can use identity-based security to automatically authenticate and authorize access to secrets, protect data in transit and at rest, and reduce risk by preventing credential exposure and unauthorized users.

In many instances, users of a secrets management system (e.g., engineers, software developers, etc.) rely on the system to prevent unwanted incidents (e.g., snooping an API call) during the development and testing phases. For example, a software engineer writing code for a service provider system may require interaction with an open-source third party system to communicate sensitive data or secrets, and that such interaction be accompanied by API or cryptographic keys to authenticate or authorize the interaction.

Hard coding the secrets into the source code creates a technical problem by making the code susceptible to attacks. That is, a nefarious actor may intercept communications and extract the API or cryptograph keys, which can result in the service provider system and/or the third party system being easily hacked. Furthermore, source code is often leaked, and if the secrets are written directly into the source code, the secrets will become available to anyone with access to the code. This increases the likelihood of an individual being able to exploit the system, e.g., the service provider system or the third party system, using the secrets in the leaked source code. Also, in an organization with many teams of engineers, different engineers may have different roles and the organization may only want certain engineers to have access to the secrets for security reasons, even if all of the engineers have access to the source code. Therefore, engineers would use a secrets management system to safely communicate such sensitive data and secrets to one another. The secrets management system typically provides a set of libraries those engineers can use to store, secure, and control access to their sensitive data and secrets.

Unfortunately, the features provided by existing secrets management systems do not necessarily conform with the requirements for an easy-to-use and secure secrets management system, and do not provide good tooling for the users. For example, secrets changes performed by those conventional systems are uncoupled from deployments, thereby causing confusion. Furthermore, credentials are replicated between regions using arcane tooling, and changing regional replication is difficult because the infrastructure would need to be replicated wherever a user needs the secrets, which makes misconfiguration or a breach more likely.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of a system architecture for a secrets management system according to an embodiment.

FIG. 2 is a block diagram of another system architecture for a secrets management system according to an embodiment.

FIG. 3 is a block diagram of a system architecture of a secrets management system communicating with a cloud platform system according to an embodiment.

FIG. 4 is a block diagram of another system architecture of a secrets management system communicating with a cloud platform system according to an embodiment.

FIG. 5 is a flow diagram of a process for encryption and use of secured secrets data according to an embodiment.

FIG. 6 is a flow diagram of a process for decryption and use of secured secrets data according to an embodiment.

FIG. 7 is an embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “generating”, “sending”, “building”, “deploying”, “obtaining”, “determining”, “decrypting”, “providing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Embodiments of the disclosure relate to a secrets management system that stores and encrypts secrets in deployed build artifacts, thereby changing the deployment model for secrets and improving on existing secrets management systems. For example, embodiments of the disclosure discussed herein can reduce the number of in-bound user requests for help around secrets management, which reduces network congestion by reducing the number of communications handled for secret management. Furthermore, some embodiments discussed herein move the majority of secrets operations to deploy (or bootstrap) time, to avoid static storage of secrets. By moving secrets operations, as discussed herein, compromising the managed secrets becomes more difficult, therefore improving the security of the secrets management. Additionally, the secrets management discussed herein extends the system to support safe credential generation and loading, to ensure users do not need to and cannot view raw credentials, and removes the user or client system dependency on fetching and updating credentials. These techniques further safeguard the generated credentials and their use by reducing exposure points and further controlling how secrets are handled.

In some embodiments, the secrets management system discussed herein provides a two-stage approach for different systems to securely deploy and fetch secrets and other sensitive information. In the first stage, the secrets management system may include a secret management service that may or may not rely upon by machines and is used by users (e.g., engineers, software developers, etc.) to generate, encrypt, and/or update a credential.

For example, a server system may receive a request for a credential from a first user system. In response to the request, the server system may generate a credential blob (e.g., a credential data object) and a signature of the credential blob. The credential blob can be stored in an encrypted format that the users can check into source control. This encrypted blob can also include unencrypted and signed metadata that specifies which entity (e.g., machine or human) is allowed to access the credential. The server system may then send the credential blob and the signature back to the first user system, where a user of the first user system can submit a service request of a service request system. The service request may be accompanied by the credential blob and the signature. Upon receiving the service request, the server system may build artifact for the requested service, where the built artifact also includes the credential blob. The server system may then deploy the built artifact and the signature to a second user system.

In some embodiments, in the second stage, the secrets management system may also include a secret decryption service that verifies the identity of a service of a service request system and the integrity of a credential blob, decrypts encrypted secrets in the blob, and provides decrypted credentials in return for access.

For example, a user of the second user system may send a decryption request to decrypt the encrypted secrets in the deployed credential blob. In response to this decryption request, the server system may obtain (e.g., extract) the credential blob from the built artifact for the requested service, and the deployed signature of the blob. The server system may then determine whether the signature of the credential blob is valid. For instance, the server system may decrypt the signature with a public key to effectively retrieve a hash. The hash may then be compared to a locally calculated hash of the blob. If they match, the signature is valid and confirms the integrity of the credential blob. If it is determined that the signature is valid, the server system may then decrypt the encrypted secrets in the credential blob to produce and return decrypted secrets to the second user system.

By performing the two-stage approach above, the secrets management system allows the critical path of fetching credentials to have minimal dependencies, thereby making fetch operations fast and reliable. Furthermore, by directly returning the decrypted credentials to the second user system for access, the secrets management system is not required to maintain a high-availability database. This improves accuracy and reduces network latency by eliminating or minimizing round trip time of communications.

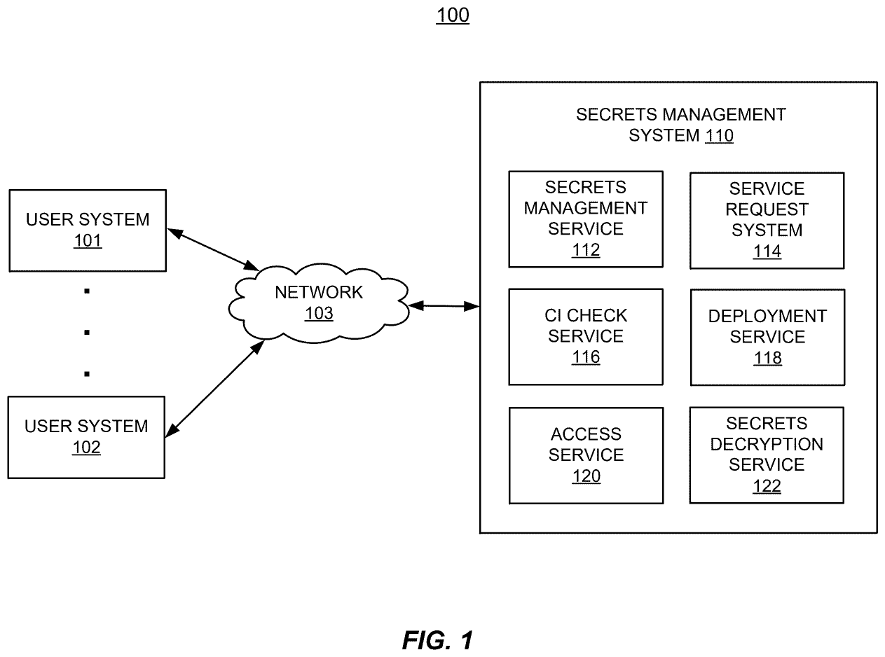

FIG. 1 is a block diagram of a system architecture for a secrets management system according to an embodiment. In one embodiment, the system 100 includes, but is not limited to, a secrets management system 110 and one or more user system(s) 101-102. User system(s) 101-102 may be computer systems, such as a desktop computer system, laptop computer system, server computer systems, etc. Secrets management system 110 may also be one or more computing devices, such as one or more server computer systems, desktop computer systems, etc.

The secrets management system 110 and the user system(s) 101-102 may be coupled to a network 103 and communicate with one another using any of the standard protocols for the exchange of information, including secure communication protocols. In one embodiment, the secrets management system 110 and the user system(s) 101-102 may run on one Local Area Network (LAN) and may be incorporated into the same physical or logical system, or different physical or logical systems. Alternatively, the secrets management system 110 and the user system(s) 101-102 may reside on different LANs, wide area networks, cellular telephone networks, etc. that may be coupled together via the Internet but separated by firewalls, routers, and/or other network devices. In one embodiment, secrets management system 110 may reside on a single server, or be distributed among different servers, coupled to other devices via a public network (e.g., the Internet) or a private network (e.g., LAN). It should be noted that various other network configurations can be used including hosted configurations, distributed configurations, centralized configurations, etc.

In an embodiment, secrets management system 110 is responsible for securely storing, managing, and controlling access to sensitive information or secrets, such as passwords, API keys, encryption keys, certificates, etc. In some embodiments, the secrets management system 110 can be used by a number of different systems to protect communications via improved secrets management. For example, data access systems, gaming systems, media distributions systems, systems that facilitate interactions between two or more systems, as well as other systems that need to protect communications communicated over networks, and also protect the secrets used to safeguard such communications, can utilize the techniques discussed herein.

In some embodiments, as discussed herein, secrets management system 110 can act as a centralized vault to protect secrets within an organization's infrastructure. By acting as a centralized vault, secrets management system 110 ensures that only authorized users (e.g., engineers, software developers, etc.) can access them and preventing unauthorized access or data breaches. As will be discussed in great detail herein, secrets management system 110 can handle secrets creations and updates, and requests from the infrastructure for those secrets.

In one embodiment, the secrets management system 110 can be a user-facing system that does not run in the instance bootstrapping path. That is, some or all features of secrets management system 110 can be directly accessible and interacted with by the users of secrets management system 110 (e.g., via a graphical user interface or command line tool), thereby enhancing the user interface or experience with the secrets management system 110.

In another embodiment, the secrets management system 110 can be run during instance bootstrapping. That is, some or all features of the secrets management system 110 can be run as backend services, e.g., on a cloud computing platform. Running secrets management system 110 as backend services can improve network latency and the scalability and security of the secrets management system.

In some embodiments, users of the secrets management system 110, where such users deploy services that utilize the secrets management system 110, can create and update credentials for use by their services, as well as create and update credential metadata with tools that communicate with the secrets management system 110. After the credential is created or updated, the user can receive a data object (also referred to as a blob) that contains encrypted secrets (or credentials) and signed metadata. In some embodiments, the data object or blob, can be stored in a predetermined location or directory next to the source code for their service. In some embodiment, the secrets may be updated, though the update may require the user to execute service request and deployment processes.

As shown in FIG. 1, secrets management system 110 includes, but is not limited to, a secrets management service 112, a service request system 114, a continuous integration (CI) check service 116, a deployment service 118, an access service 120, and a secrets decryption service 122.

In some embodiments, secrets management service 112 is responsible for generating credentials and/or safely storing existing credentials. For instance, a user of user system 101, such as an engineer developing code for a service provider system, may interact with secrets management service 112 over network 103 by sending a request to generate a new credential. In response to the request, secrets management service 112 may create a credential blob that includes encrypted secrets. The secrets may be encrypted using an authenticated symmetric encryption technique, such as XChaCha20-Poly1305, AES256-GCM, AES256-CBC, or any suitable cryptographic algorithm.

In some embodiments, the blob may also include unencrypted and signed metadata that specifies who (machine or human) is allowed to access the secrets in the credential blob. The metadata, for example, may include a folder structure of the secrets and one or more access control lists (ACLs) that determine a list of users that are allowed to update or modify the secrets. Such access control, encoded within the credential blob, serves to define whether a service or user seeking to use a credential blob is a true and authorized use of the credential blob, which can reduce misuse and/or appropriation of secrets by unintended parties. That is, if a user or client system seeking to use a credential blob is not on an ACL, then their requests can be rejected during an authentication of service. Secrets management service 112 may then send the credential blob, having the encrypted credentials and the unencrypted and signed metadata, to the user system 101.

In some embodiments, the credential blob may be formatted in a YAML structure or any suitable structure that provides rules for defining and storing data and is both human and machine readable, such as extensible markup language (XML). Accordingly, the YAML structure may encapsulate the metadata and encrypted credential components, previously described, within a credential blob.

Upon receiving the credential blob, the user system 101 can store it in a predetermined storage location or directory next to the source code for their service. For example, the blob can be stored and encrypted in a source code repository so that individual artifacts would have consistent credentials. Furthermore, by user system 101 storing the credential blob, the secrets management system 110 effectively does not have to maintain a high-availability database, reducing the complexity of secrets management. Furthermore, by storing the credential blob in the code repository, secrets updates can rely on existing change management processes. As discussed, the metadata of the credential blob may be stored by user system 101 in an unencrypted form. This way, any user in possession of the credential blob can view the metadata. This, for example, would allow system 110 to implement checks in CI (discussed in more detail herein below) to ensure that the secrets are valid and that a service would have access to the secrets it uses.

In some embodiments, the user system 101 for which the credential blob was created, and which stores the credential blob, can submit a service request for a service using the received credential blob to service request system 114. The service request uses the credential blob to authorize and/or authenticate the service request. In response to the service request, system 114 may build one or more artifacts for the service, with the built artifact including the credential blob.

For example, every running service may run from its own build artifact. The build artifact can be binaries that are built whenever a commit is pushed (including when a feature branch is merged into a master branch, which may kick off a new set of builds). When a service uses secrets, that build artifact may also include the credential blob (e.g., YAML contents), and the signature, contained in the binary for the service running.

In an embodiment, when a service is first deployed (bootstraps), some libraries may make a network call to the secrets management system 110. This network call may include the credential blob and the signature (which may be a part of the service artifact itself) as data.

As discussed in more detail herein below, when receiving this network call, the secrets management system 110 may perform the necessary authorization. For example, it may verify that the credential blob is correctly signed, and that the principal requesting to decrypt the secret is listed on the ACL. Once it authorizes the request, it decrypts the secret using, for example, a scheme was used to encrypt it in the first place, and returns the raw bytes of the secret to the caller.

As an example, in certain open-source programming language, the service code will include code that assigns the credential blob/signature to variables and makes the network calls. Thus, the service artifact, which may be a compiled binary of the service code, can include logic to make that network call. Other programming languages may work similarly, though they may not literally assign blobs to variables.

CI check service 116 is enabled to check the credential validity of the credential blob from the built artifact to ensure directory structures of the credential blob are well-formed. By checking the formation of the directory structure, CI check service 116 is able to reject malformed requests, which reduces the possibility of improper requests being forwarded to one or more downstream systems or services. CI check service 116 can also enforce code ownership in a way that mirrors an ACL, and validate that a given service will have access to the secrets at run time when the service or user system is identified on the ACL or authorization listing. These operations of the CI check service 116 allow the secrets management system 110 to provide immediate feedback, about whether their credential blob is well formed and that their service is authorized to perform one or more operations, to user systems 110 early (e.g., pre-deployment), rather than having the user systems 110 find out at deploy time.

As an example, every repository will have an independent set of credential blobs. The repository may be a source code repository that stores the source code developed by the user (e.g., user of user system 101), and it may be maintained by the user system (e.g., user system 101 or 102). CI check service 116 may enforce the folder structure of the repository to match the secrets folder structure specified in the blob. This makes credential changes as part of a single service request easier to follow, rather than requiring a separate repository or vendor between multiple repositories.

If CI checks performed by CI check service 116 pass, the service request is approved and the user system may deploy the service and built artifact via deployment service 118. For example, deployment service 118 may deploy the service and anything built from the folder structure of the repository that contains the new version of the credential blob. Service 118 may then obtain or fetch the built artifact from the location it is stored at, and deploy the built artifact out to access service 120 of system 110.

A user of user system 102 may then request a decrypted value of the encrypted secrets in the credential blob by interacting with access service 120 over network 103. This user, for example, may be another engineer developing code for a third party system that is responsible for performing the services for the service provider system. The user system 102 may need the decrypted secrets in order to develop the software to properly operate with the service provider system.

As an example, the user may send a credential decryption request to access service 120 to obtain the decrypted secrets, such as to authenticate a service request using encrypted secrets in a credential blob. At deploy time, access service 120 may make an API call and send the credential blob from the built artifact to the secrets decryption service 122, where the decryption service 122 then verifies the identity of the service and the integrity of the blob. For example, the service identity may be validated by checking the identity against one or more credential ACLs in the blob.

In some embodiments, decryption service 122 can validate the integrity of the blob by verifying the signature of the credential metadata with a public key. If the service identity is authorized to decrypt the encrypted secrets and the blob integrity verification passes, decryption service 122 may decrypt the encrypted secrets from the credential blob and return the decrypted (raw) value of the secrets to the user of user system 102. The decrypted value may be executed by user system 102 or stored by the service, for example, as a variable. As an example, if the decrypted value (secret) is a cryptographic key or an API function call, the decrypted value may be added to the source code, as a variable, by the user of user system 102.

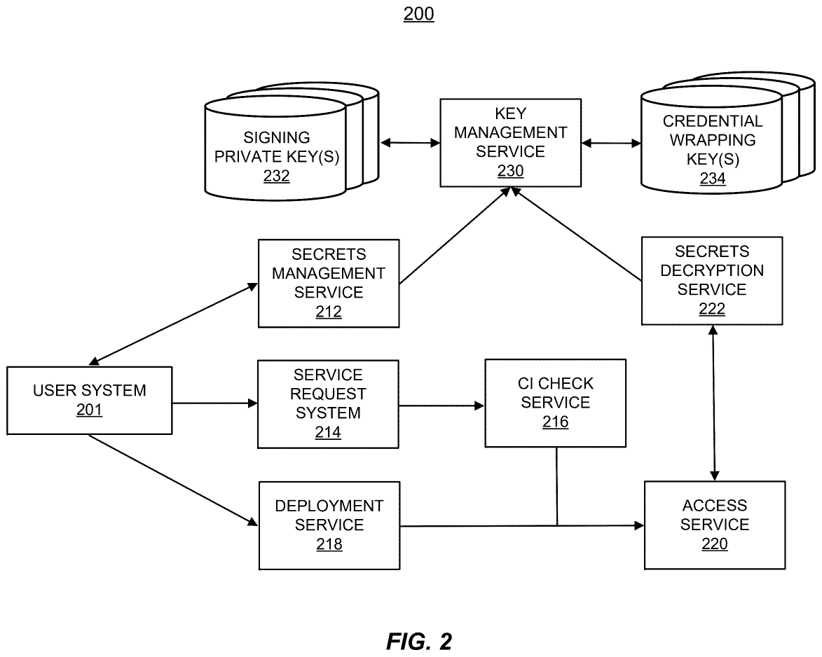

FIG. 2 is a block diagram of another system architecture for a secrets management system according to an embodiment. In one embodiment, the system 200 includes, but is not limited to, a secrets management service 212, service request system 214, CI check service 216, deployment service 218, access service 220, secrets decryption service 222, and key management service 230. Note that in some embodiments, components 212-222 of FIG. 2 may respectively correspond to components 112-122 of FIG. 1 described above.

Referring to FIG. 2, user system 201 may send a request for a new credential to secrets management service 212. Responsive to the request, secrets management service 212 may generate a credential blob having one or more secrets or credentials, and metadata associated with the secrets. As discussed, the metadata includes the folder structure of the secrets and one or more ACLs that specify who (machine or human) is allowed to access the secrets. As also discussed, the credential blob may be in the form of a YAML structure (or file) or any suitable structure that provides rules for defining and storing data and is both human and machine readable, such as XML structure.

Subsequently, secrets management service 212 may invoke key management service (KMS) 230 for a credential wrapping key in order to encrypt the secrets. KMS 230 serves to manage cryptographic keys and their metadata. For example, KMS 230 is responsible for the generation, distribution, storage, rotation, deletion, backup and recovery, revocation, and/or destruction of the cryptographic keys. When KMS 230 is invoked, KMS 230 may obtain or fetch a credential wrapping key from a credential wrapping keys data store 234 (e.g., a database) for service 212, and service 212 may use the credential wrapping key to encrypt the secrets in the blob. The key, for example, may be any randomly-generated key, such as XChaCha20-Poly1305 or any suitable key in accordance with a cryptographic algorithm. In some embodiments, the obtained credential wrapping key (also referred to as credential encryption key (CEK)) may also itself be encrypted using another wrapping key (e.g., AES-256-GCM) from data store 234.

KMS 230 may then obtain or fetch a signing private key from signing private keys data store 232, and service 212 may sign some or the entire credential blob with the signing private key. In an embodiment, the signature of the credential blob may be maintained as a detached signature. The signature may include the exact byte contents of the credential blob (e.g., YAML file) to ensure that they have not been tampered. In some embodiments, the signing private key may only exist in the cluster of secret management service 212, though in other embodiments, the key may exist in other clusters (e.g., cloud service cluster). In some embodiments, KMS 230 also supports automated key rotation for credentials. For example, KMS 230 may rotate the keys in data stores 232 and 234 periodically (e.g., monthly or annual basis). Key rotation can ensure the encrypted secrets are not leaked in the event one of those keys is leaked.

With continued reference to FIG. 2, the encrypted and signed blob may be sent back to user system 201 from secrets management service 212 and the user system 201 may effectively use the blob to submit a service request to service request system 214. For example, user system 201 may submit a service request for a service of service request system 214, and responsive to the request, system 214 may perform a build of artifact for the service and the artifact may include the credential blob.

As discussed, CI check service 216 can validate the credential validity of the credential blob from the built artifact to ensure certain parameters are passed. One parameter CI check service 216 may enforce is the folder structure of the secrets. For example, CI check service 216 may require the secrets folder structure to have at least one credential blob (e.g., YAML file) present for the secrets to be accessible. Another parameter service 216 may enforce is the folder structure in a repository. For example, a code repository may have a set of credential blobs and service 216 may require the folder structure in the repository to match the secrets folder structure. Yet another parameter service 216 may enforce is code ownership. For example, each secrets folder structure (or directory) has code ownership enforced, and as such, service 216 may verify the user (e.g., user of user system 201) to ensure the user is on the credential ACL of the blob. The users specified on the ACL, for example, are users that are allowed to update or otherwise modify a secret.

Once the credential blob is validated, the service request is approved and the user system 201 may effectively deploy the service and built artifact via deployment service 218. As discussed, service 218 may deploy the service and anything built from the folder structure of the repository that contains the new version of the credential blob. Subsequently, service 218 may obtain the built artifact from the location it is stored and deploy the built artifact out to access service 220.

Another user system (not shown) may communicate with access service 220 to request decrypted secrets from the credential blob. In doing so, the user system may make a credential decryption request to the access service 220 with a service identity and the blob. At deploy time, access service 220 may make an API call and send the credential blob from the built artifact to the secrets decryption service 222.

Upon receiving the blob, secrets decryption service 222 may validate the identity and the provided blob. For example, to validate the identity, service 222 may check the identity against an ACL in the blob. If the identity exists on the ACL, service 222 may determine the identity is validated or authorized. Otherwise, service 222 may determine the identity is unauthorized. Furthermore, to validate the provided blob, service 222 may verify the signature of the credential blob with a public key. For instance, service 222 may invoke KMS 230 to obtain the public key (not shown) and use the public key to decrypt the signature, effectively retrieving a hash. The hash may then be compared to a locally calculated hash of the blob. If they match, the signature is valid and confirms the integrity of the credential blob.

Once the identity and the blob are validated, service 222 may invoke KMS 230 to obtain a credential wrapping key from keys data store 234. Decryption service 222 may decrypt the encrypted secrets from the credential blob using the wrapping key, and return the decrypted (raw) value of the secrets to access service 220, where the user system can access the decrypted secrets and store the secrets, for example, as a variable.

As a result, by performing this two-factor validation (i.e., validating both the service identity against the ACL structure and the signature of the credential blob), security is significantly improved. That is, not only does the service identity have to match that in the ACL structure, the signature of the blob also has to match with the locally computed hash. Therefore, a nefarious actor is prevented from performing an unauthorized decryption to obtain the secrets by modifying the content of the credential blob.

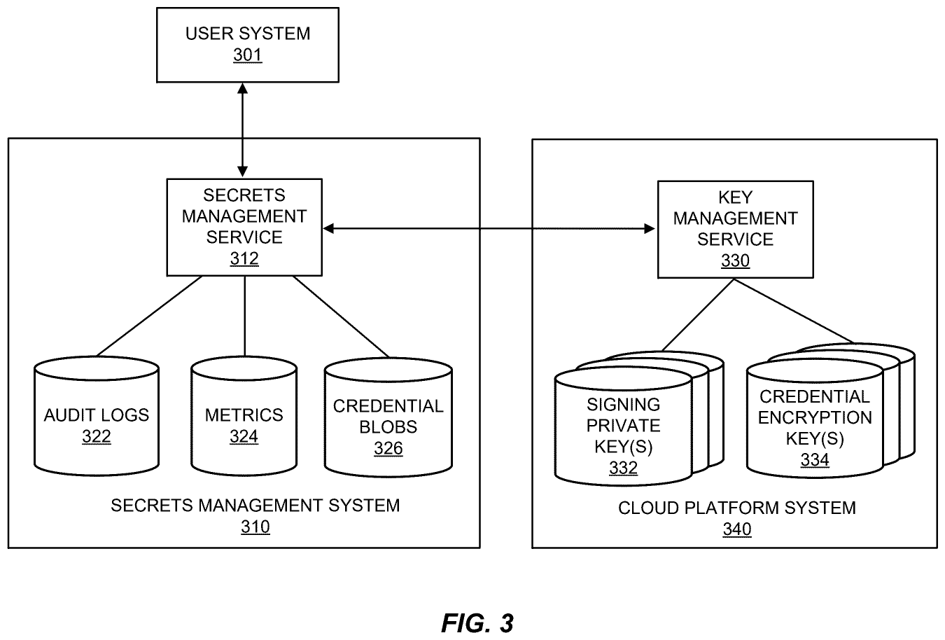

FIG. 3 is a block diagram of a system architecture of a secrets management system communicating with a cloud platform system according to an embodiment. As discussed above, when user system 301 sends a request to secrets management service 312 of secrets management system 310 for a credential, service 312 generates a raw credential blob in response to the request. In an embodiment, service 312 is a machine-facing service that provides direct access to raw credentials or secrets. Therefore, service 312 may obtain the raw secrets and include them in the credential blob. Service 312 may then encrypt and sign the credential blob. For example, service 312 may communicate with a key management service (KMS) 330 of cloud platform system 340 via, for example, an API call. In response to the API call, KMS 330 may fetch a credential encryption key (CEK) and a signing private key from CEK data store 334 and signing private keys data store 332, respectively, and send those keys back to secrets management service 312. Using the wrapping and signing keys, service 312 may encrypt and sign the credential blob, and store the encrypted and signed credential blob in credential blobs data store 326 coupled to system 310.

In some embodiments, cloud platform system 340 can be any cloud computing platform. Cloud platform system 340 may host a number of cloud service clusters, with each cluster having KMS 330 and keys data stores 332 and 334. For example, system 340 may host a primary cluster and a secondary cluster, each with an instance of KMS 330 and the data stores 332 and 334. Additionally, system 340 may host a recovery cluster. In the recovery cluster, the CEKs in data store 334 may additionally be encrypted and stored as KMS keys for backup access. In some embodiments, at credential encryption time, KMS access from secrets management service 312 may require all clusters be available. In other words, service 312 may not be able to obtain the keys for encryption unless all of the primary, secondary and recovery clusters are available.

Still referring to FIG. 3, secrets management service 312 may also track, store and maintain one or more audit logs in audit logs data store 322. The audit logs may include a chronological record of events, actions, and/or changes that occur within system 310. For example, the audit logs 322 may establish a trail of user activities of the user of user system 301. The audit logs may include successful and failed credential requests from the user system 301, successful and failed API calls to key management service 330, successful and failed generations of the credential blobs, etc. The audit logs, for example, can be used to analyze events after the fact, detect patterns of behavior in the user activities (e.g., potential tamper), etc., to ensure accountability and traceability.

In some embodiments, secrets management service 312 may track, store and maintain certain metrics in metrics data store 324. For example, service 312 may track metrics that show adoption of safe secrets management practices across different user systems. These metrics may include a percentage of secrets that were generated within the secrets management system 310, a percentage of secrets having an assigned type, number of secrets managed by system 310, frequency of secrets management-related incidents, etc. Service 312 may also track operational metrics to ensure users are successfully working with the secrets. The operational metrics may include p90 wall-clock time for secret creations, updates, and generations. The p90 wall-clock time refers to the actual elapsed time on a standard (wall) clock for 90% of the services performed by secrets management service 312, e.g., the secret creations, updates, and/or generations, to complete. The metrics can be used to detect user practices to ensure the users adopt safe secrets management practices across the user systems and are successfully working with the secrets without issues.

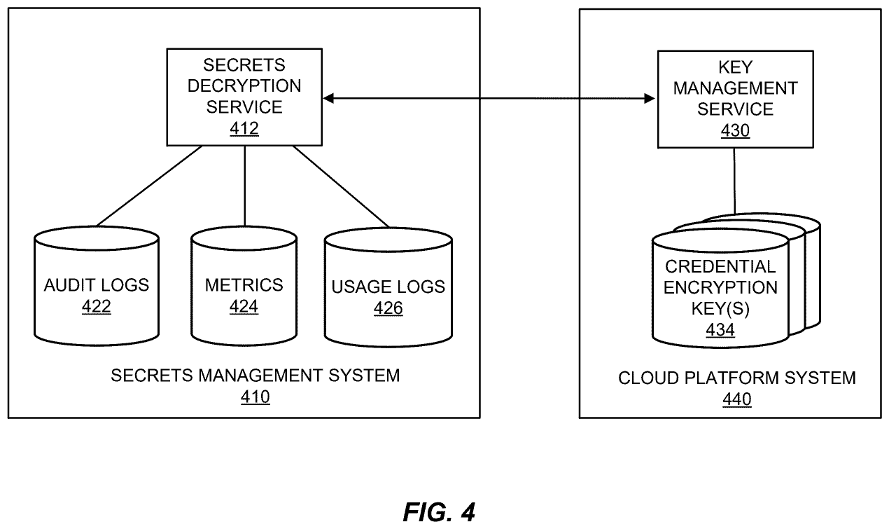

FIG. 4 is a block diagram of another system architecture of a secrets management system communicating with a cloud platform system according to an embodiment. In FIG. 4, when secrets decryption service 412 of secrets management system 410 is invoked, for example by an access service via an API call, decryption service 412 may decrypt the encrypted secrets in the credential blob provided by the access service. As an example, decryption service 412 may communicate with a KMS 430 of cloud platform system 440 via, for example, an API call. In response to the communication, KMS 430 may fetch a credential encryption key (CEK) in CEKs data store 434. KMS 430 may send the CEK back to decryption service 412, where decryption service 412 may decrypt the encrypted secrets using the CEK and return the decrypted secrets or value to the access service.

As discussed, cloud platform system 440 can be any cloud computing platform. Cloud platform system 440 may host multiple cloud service clusters, with each cluster having an instance of KMS 430 and data store 434. That is, system 440 may host a primary cluster and a secondary cluster, each with an instance of KMS 430 (e.g., AWS KMS) and the data store 434. Additionally, cloud platform system 440 may host a recovery cluster, where in the recovery cluster, the CEKs in data store 434 may be encrypted to KMS keys for backup access. Unlike the cloud platform system 340 of FIG. 3, at credential decryption time, KMS access from secrets decryption service 412 does not require all clusters be available. That is, the decryption service 412 allows the secrets to be decrypted even if some of the clusters are unavailable.

As shown in FIG. 4, secrets decryption service 412 may track, store and maintain audit logs, metrics, and usage logs respectively in data stores 422, 424 and 426. The audit logs may include a chronological record of events, actions, and/or changes that occur within system 410. For example, the audit logs may establish a trail of user activities of a user interacting with the access service. The audit logs may include, for example, successful and failed credential decryption requests from the user, successful and failed API calls to key management service 430, successful and failed decryptions of the encrypted secrets, etc. The metrics tracked by decryption service 412 may include operational metrics to ensure users are working with the secrets successfully. Some examples of those metrics may include p90 wall-clock time of access requests as seen by the secrets access service, a percentage of access requests that encounter decryption failures, etc. The p90 wall-clock time of access requests refers to the actual elapsed time on a standard (wall) clock for 90% of the access requests of the decryption service 412 to complete. The usage logs tracked by decryption service 412 may keep a record of all issued credential blobs to track credential usage (i.e., usage of the decrypted secrets).

In embodiments, having multiple instances of KMS 430 respectively in different cloud service clusters enables the service to be highly available and increases reliability of the secrets management system 410. Thus, in the embodiment of FIG. 4, if a cluster in cloud platform system 440 becomes unavailable, KMS 430 will still be accessible by secrets management system 410 through other clusters to obtain the CEKs for performance of the decryption service.

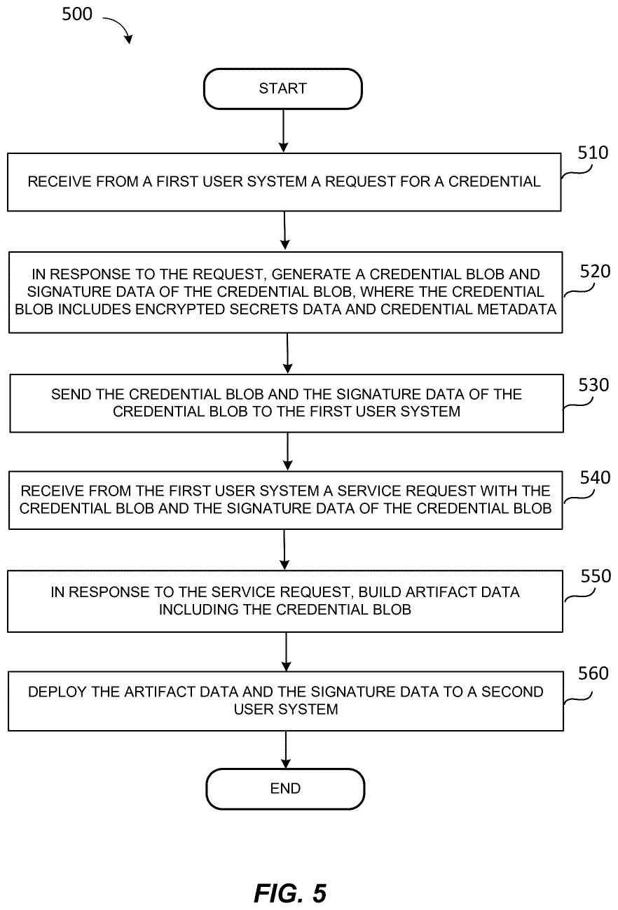

FIG. 5 is a flow diagram of a process for encryption and use of secured secrets data according to an embodiment. Method 500 may be performed by processing logic that may comprise hardware (circuitry, dedicated logic, etc.), software (such as is run on a general purpose computer system or a dedicated machine), firmware, or a combination. In one embodiment, the method 500 is performed by secrets management system 110 of FIG. 1 (e.g., secret management service 112, service request system 114, CI check service 116, and deployment service 118).

Referring to FIG. 5, at block 510, the processing logic may receive a request for a credential. For example, a user of a user system (e.g., user system 101), such as an engineer developing code for a service provider system, may interact with a secrets management service (e.g., secrets management service 112) to send a request to generate a new credential.

At block 520, in response to the request, the processing logic may generate a credential blob and signature data of the credential blob. The credential blob may include encrypted secrets data and credential metadata. For example, the secrets management service may invoke a KMS (e.g., KMS 230) for a credential wrapping key (or CEK) to encrypt the secrets. In response to the invocation, the KMS may fetch the wrapping key from a wrapping keys data store (e.g., wrapping key data store 234) and pass the key to the secrets management service. The secrets management service may use the credential wrapping key to encrypt the secrets data in the blob. The key, for example, may be any randomly-generated key, such as XChaCha20-Poly1305 or any suitable key in accordance with a cryptographic algorithm. The KMS may also fetch a signing private key from a signing private keys data store (e.g., signing private keys data store 232) and pass the signing key to the secrets management service. The secrets management service may sign some or the entire credential blob with the signing private key to produce the signature data of the credential blob.

At block 530, the processing logic may send the credential blob and the signature data to a first user system. The first user system, for example, may be user system 101 of FIG. 1. In an embodiment, the first user system may use the credential blob to submit a service request to a service request system (e.g., service request system 214).

At block 540, the processing logic may receive a service request with the credential blob and the signature data of the credential blob. In some embodiments, the service request uses the credential blob to authorize and/or authenticate the service request.

At block 550, in response to the service request, the processing logic may build artifact data, where the artifact data includes the credential blob. As discussed, every running service may run from its own build artifact. The build artifact can be binaries that are built when a commit is pushed, including when a feature branch is merged into a master branch, which may kick off a new set of builds. When a service uses secrets, that build artifact may also include the credential blob (e.g., YAML contents), and the signature, contained in the binary for the service running.

As also discussed, when a service is first deployed (bootstraps), some libraries may make a network call to the secrets management system. This network call may include the credential blob and the signature, which may be a part of the service artifact itself, as data.

At block 560, the processing logic may deploy the artifact data and the signature data to a second user system (e.g., user system 102 of FIG. 1). As discussed, the artifact data may be deployed if the service request is approved. In order for the service request to be approved, the credential blob is to be validated. For example, a CI check service (e.g., CI check service 216) can validate the credential validity of the credential blob from the built artifact data to ensure certain parameters are passed. That is, the check service may require the secrets folder structure to have at least one credential blob (e.g., YAML file) present for the secrets to be accessible. The check service may also enforce the folder structure in a code repository. For example, the code repository may have a set of credential blobs and the CI check service may require the folder structure in the repository to match the secrets folder structure. The check service may further enforce code ownership. That is, each secrets folder structure has code ownership enforced, and thus, the CI check service may verify the user (e.g., user of user system 201) to ensure the user is on the credential ACL of the blob. Accordingly, once the credential blob is validated, the service request is approved and the artifact data and the signature data can be deployed to the second user system.

As a result, by enforcing the various CI check parameters discussed above, security is improved as only authorized users specified in the credential ACL can deploy the built artifact data. Moreover, the enforcement of the folder structures also ensures the credential blob (and thus the secrets) is accessible by the user of the second user system, thereby avoiding a re-deployment of the artifact data and delay in getting the secrets to the user.

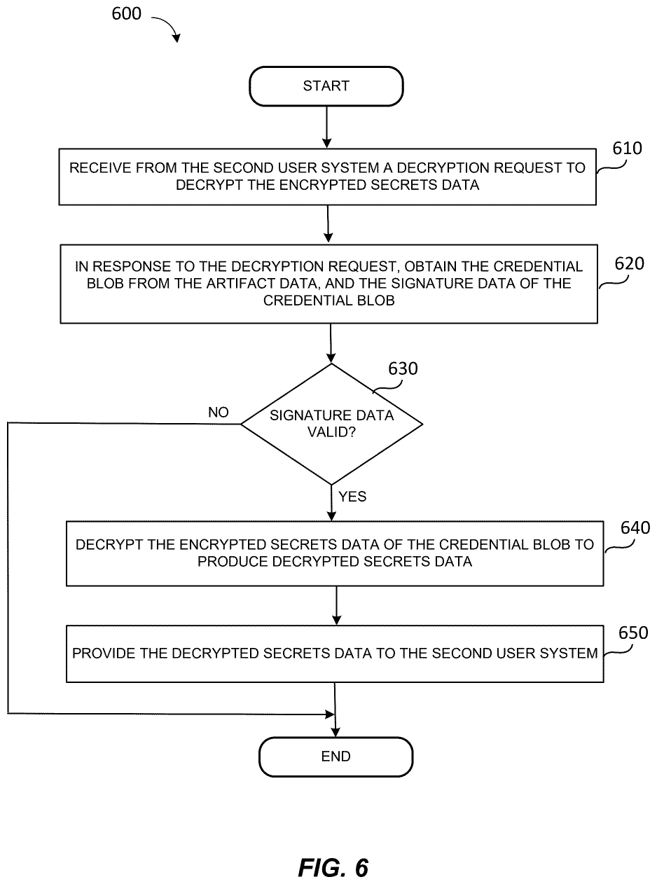

FIG. 6 is a flow diagram of a process for decryption and use of secured secrets data according to an embodiment. Method 600 may be performed by processing logic that may comprise hardware (circuitry, dedicated logic, etc.), software (such as is run on a general purpose computer system or a dedicated machine), firmware, or a combination. In one embodiment, the method 600 is performed by secrets management system 110 of FIG. 1 (e.g., access service 120 and secrets decryption service 122).

Referring to FIG. 6, at block 610, the processing logic may receive a decryption request to decrypt the encrypted secrets data. For example, a user of another user system (e.g., user system 102) may communicate with an access service (e.g., access service 220) to request the decrypted secrets from the credential blob. In doing so, that other user system may make a credential decryption request to the access service accompanied by a service identity and the blob.

At block 620, in response to the decryption request, the processing logic may obtain the credential blob from the built artifact data, and the signature data of the credential blob. As discussed below, when receiving the network call, the secrets management system may perform the necessary authorization. For example, the secrets management system may verify that the credential blob is correctly signed, and that the principal requesting to decrypt the secret is listed on the ACL. Once it authorizes the request, it may decrypt the secret using, for example, a scheme was used to encrypt it in the first place, and returns the raw bytes of the secret to the caller.

As previously discussed, in certain open-source programming language, the service code will include code that assigns the credential blob/signature to variables and makes the network calls. Thus, the service artifact, which may be a compiled binary of the service code, can include logic to make that network call. Other programming languages may work similarly, though they may not literally assign blobs to variables.

At block 630, the processing logic may determine whether the signature data of the credential blob is valid. For example, to validate the signature data, a secrets decryption service (e.g., decryption service 222) may verify the signature data of the credential blob with a public key. The secrets decryption service may invoke a KMS (e.g., KMS 230) to obtain the public key and use the public key to decrypt the signature, effectively retrieving a hash. The hash may then be compared to a locally calculated hash of the blob. If they match, the signature data is determined to be valid and confirms the integrity of the credential blob. At block 630, if the signature data is determined to valid, the processing logic proceeds to block 640. Otherwise, process 600 ends.

At block 640, the processing logic may decrypt the encrypted secrets data of the credential blob to produce decrypted secrets data (or a decrypted value). For example, the secrets decryption service may invoke the KMS to obtain a credential wrapping key from a keys data store (e.g., keys data store 234). The decryption service may then decrypt the encrypted secrets data from the credential blob using the credential wrapping key.

At block 650, the processing logic may provide the decrypted secrets data to the second user system (e.g., user system 102). That is, the secrets decryption service may return the decrypted (raw) value of the secrets data to the access service, where the other user system can access the decrypted secrets data and store the secrets, e.g., as a variable.

As a result, by validating the signature data of the credential blob prior to the decryption of the encrypted secrets data in the blob, security is improved as method 600 ensures the credential blob has not been tampered prior to the decryption. This way, a nefarious actor is prevented from performing an unauthorized decryption to obtain the secrets data by modifying the content of the credential blob.

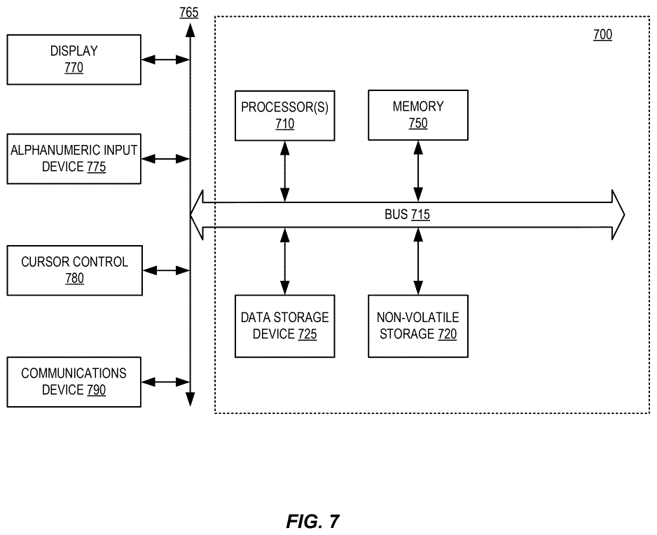

FIG. 7 is an embodiment of a computer system that may be used to support the systems and operations discussed herein. The data processing system illustrated in FIG. 7 includes a bus or other internal communication means 715 for communicating information, and one or more processors 710 coupled to the bus 715 for processing information. The system further comprises a random access memory (RAM) or other volatile storage device 750 (referred to as memory), coupled to bus 715 for storing information and instructions to be executed by processor(s) 710. Main memory 750 also may be used for storing temporary variables or other intermediate information during execution of instructions by processor(s) 710. The system also comprises a read only memory (ROM) and/or static storage device 720 coupled to bus 715 for storing static information and instructions for processor(s) 710, and a data storage device 725 such as a magnetic disk or optical disk and its corresponding disk drive. Data storage device 725 is coupled to bus 715 for storing information and instructions.

The system may further be coupled to a display device 770, such as a light emitting diode (LED) display or a liquid crystal display (LCD) coupled to bus 715 through bus 765 for displaying information to a computer user. An alphanumeric input device 775, including alphanumeric and other keys, may also be coupled to bus 715 through bus 765 for communicating information and command selections to processor(s) 710. An additional user input device is cursor control device 780, such as a touchpad, mouse, a trackball, stylus, or cursor direction keys coupled to bus 715 through bus 765 for communicating direction information and command selections to processor(s) 710, and for controlling cursor movement on display device 770.

Another device, which may optionally be coupled to computer system 700, is a communication device 790 for accessing other nodes of a distributed system via a network. The communication device 790 may include any of a number of commercially available networking peripheral devices such as those used for coupling to an Ethernet, token ring, Internet, or wide area network. The communication device 790 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 750, mass storage device 725, or other storage medium locally or remotely accessible to processor 710.

It will be apparent to those of ordinary skill in the art that the system, method, and process described herein can be implemented as software stored in main memory 750 or read-only memory 720 and executed by processor(s) 710. This control logic or software may also be resident on an article of manufacture comprising a computer readable medium having computer readable program code embodied therein and being readable by the mass storage device 725 and for causing the processor(s) 710 to operate in accordance with the methods and teachings herein.

The embodiments discussed herein may also be embodied in a handheld or portable device containing a subset of the computer hardware components described above. For example, the handheld device may be configured to contain only the bus 715, the processor(s) 710, and memory 750 and/or 725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include processor(s) 710, a data storage device 725, a bus 715, and memory 750, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method for using secured secrets by distributed systems, the method comprising:
receiving, by a server system from a first user system, a request for a credential;
in response to the request, generating, by the server system, a credential blob and signature data of the credential blob, the credential blob including encrypted secrets data and credential metadata;
sending, by the server system to the first user system, the credential blob and the signature data of the credential blob;
receiving, by the server system from the first user system, a service request with the credential blob and the signature data of the credential blob;
in response to the service request, building, by the server system, artifact data including the credential blob; and
deploying, by the server system, the artifact data and the signature data to a second user system.

2. The method of claim 1, further comprising:
receiving, by the server system from the second user system, a decryption request to decrypt the encrypted secrets data;
in response to the decryption request, obtaining, by the server system, the credential blob from the artifact data, and the signature data of the credential blob;
determining, by the server system, whether the signature data of the credential blob is valid;
in response to determining that the signature data of the credential blob is valid, decrypting, by the server system, the encrypted secrets data of the credential blob to produce decrypted secrets data; and
providing, by the server system, the decrypted secrets data to the second user system.

3. The method of claim 2, wherein the encrypted secrets data of the credential blob is decrypted using a credential wrapping key.

4. The method of claim 2, further comprising:
in response to the decryption request, validating, by the server system, a service identity authorized to decrypt the encrypted secrets data.

5. The method of claim 4, wherein validating the service identity authorized to decrypt the encrypted secrets data comprises checking the service identity against an access control list in the credential blob.

6. The method of claim 1, further comprising:
encrypting, by the server system, secrets data using a credential wrapping key to produce the encrypted secrets data.

7. The method of claim 1, wherein the signature data of the credential blob is signed using a signing private key.

8. The method of claim 1, wherein the credential metadata is unencrypted.

9. One or more non-transitory computer readable storage media having instructions stored thereupon which, when executed by a server system having at least a processor and a memory therein, cause the server system to perform operations, the operations comprising:
receiving, by a server system from a first user system, a request for a credential;
in response to the request, generating, by the server system, a credential blob and signature data of the credential blob, the credential blob including encrypted secrets data and credential metadata;
sending, by the server system to the first user system, the credential blob and the signature data of the credential blob;
receiving, by the server system from the first user system, a service request with the credential blob and the signature data of the credential blob;
in response to the service request, building, by the server system, artifact data including the credential blob; and
deploying, by the server system, the artifact data and the signature data to a second user system.

10. The non-transitory computer readable storage media of claim 9, wherein the operations further comprise:
receiving, by the server system from the second user system, a decryption request to decrypt the encrypted secrets data;
in response to the decryption request, obtaining, by the server system, the credential blob from the artifact data, and the signature data of the credential blob;
determining, by the server system, whether the signature data of the credential blob is valid;
in response to determining that the signature data of the credential blob is valid, decrypting, by the server system, the encrypted secrets data of the credential blob to produce decrypted secrets data; and
providing, by the server system, the decrypted secrets data to the second user system.

11. The non-transitory computer readable storage media of claim 10, wherein the encrypted secrets data of the credential blob is decrypted using a credential wrapping key.

12. The non-transitory computer readable storage media of claim 10, wherein the operations further comprise: in response to the decryption request, validating, by the server system, a service identity authorized to decrypt the encrypted secrets data.

13. The non-transitory computer readable storage media of claim 12, wherein validating the service identity authorized to decrypt the encrypted secrets data comprises checking the service identity against an access control list in the credential blob.

14. The non-transitory computer readable storage media of claim 9, wherein the operations further comprise: encrypting, by the server system, secrets data using a credential wrapping key to produce the encrypted secrets data.

15. The non-transitory computer readable storage media of claim 9, wherein the signature data of the credential blob is signed using a signing private key.

16. The non-transitory computer readable storage media of claim 9, wherein the credential metadata is unencrypted.

17. A server system, comprising:
a memory; and
a processor coupled with the memory configured to perform operations comprising:
receiving, by a server system from a first user system, a request for a credential;
in response to the request, generating, by the server system, a credential blob and signature data of the credential blob, the credential blob including encrypted secrets data and credential metadata;
sending, by the server system to the first user system, the credential blob and the signature data of the credential blob;
receiving, by the server system from the first user system, a service request with the credential blob and the signature data of the credential blob;
in response to the service request, building, by the server system, artifact data including the credential blob; and
deploying, by the server system, the artifact data and the signature data to a second user system.

18. The server system of claim 17, wherein the operations further comprise:
receiving, by the server system from the second user system, a decryption request to decrypt the encrypted secrets data;
in response to the decryption request, obtaining, by the server system, the credential blob from the artifact data, and the signature data of the credential blob;
determining, by the server system, whether the signature data of the credential blob is valid;
in response to determining that the signature data of the credential blob is valid, decrypting, by the server system, the encrypted secrets data of the credential blob to produce decrypted secrets data; and
providing, by the server system, the decrypted secrets data to the second user system.

19. The server system of claim 18, wherein the encrypted secrets data of the credential blob is decrypted using a credential wrapping key.

20. The server system of claim 19, wherein the operations further comprise: in response to the decryption request, validating, by the server system, a service identity authorized to decrypt the encrypted secrets data.
